(19) United States
(12) Patent Application Publication
(10) Pub. No.: US 2026/0277699 A1
(43) Pub. Date: Sep. 17, 2026

(54) MANAGING RESOURCE TAG SYNTAX COMPLIANCE IN HYBRID CLOUD COMPUTING ENVIRONMENTS

(71) Applicant: Hewlett Packard Enterprise Development LP, Spring, TX (US)

(72) Inventors: Thirukkannan Mookkaiah, Bangalore Karnataka (IN); John Lenihan, Galway (IE); Santosh Nagaraj, Bangalore Karnataka (IN); Guoping Jia, Gieres (FR)

(21) Appl. No.: 19/270,566

(22) Filed: Jul. 16, 2025

(30) Foreign Application Priority Data
Mar. 11, 2025 (EP) 25305320.1

(51) Int. Cl. G06F 9/50; H04L 67/02

(52) U.S. Cl. CPC G06F 9/5072; H04L 67/02

(57) ABSTRACT

A technique includes receiving an API request. The API request includes data representing a candidate tag for a resource associated with a hybrid cloud computing environment. The hybrid cloud computing environment is associated with a plurality of cloud service providers. The technique incudes managing a resource tag syntax compliance, including determining, for each ruleset of a plurality of rulesets, whether the candidate tag complies with the ruleset. Each ruleset is associated with a different cloud service provider. Managing the resource tag syntax compliance includes, based on the determination, providing an API response. The API response represents whether the candidate tag is valid for the hybrid cloud computing environment.

### BACKGROUND

A cloud service provides on demand and scalable virtual and/or physical resources. A cloud service has an associated application programming interface (API) for purposes of provisioning, deploying and managing the resources.

### BRIEF DESCRIPTION OF THE DRAWINGS

FIG. 1 is a block diagram of a hybrid cloud computing environment having a unified API that provides a centralized tagging service solution, according to an example implementation.

FIG. 2 is an illustration of a unified API architecture to validate resource tags and remediate resource tag non-compliance, according to an example implementation.

FIG. 3 is a flow diagram depicting a technique performed by a unified API handler to process a candidate resource tag validity inquiry and remediate candidate resource tag non-compliance, according to an example implementation.

FIG. 4 is an illustration of a unified API architecture to add, modify or replace a tag validity ruleset, according to an example implementation.

FIG. 5 is a flow diagram depicting a technique performed by a unified API handler to process a request to add or modify a resource tag validity ruleset, according to an example implementation.

FIG. 6 is a flow diagram depicting a technique to determine, for a hybrid cloud computing environment, whether a candidate resource tag complies with cloud service provider associated rulesets, according to an example implementation.

FIG. 7 is an illustration of a non-transitory storage medium that stores hardware processor-readable instructions that, when executed by a hardware processor, cause a unified API for a hybrid cloud computing environment to update a ruleset defining a permissible resource tag syntax, according to an example implementation.

FIG. 8 is a block diagram of a system that includes a hardware processor to determine whether a resource tag is valid for use in a hybrid cloud computing environment, according to an example implementation.

### DETAILED DESCRIPTION

Cloud services may be a viable option for a business entity for any of a number of different reasons, such as wide accessibility, on-demand resource scaling, reduction of information technology (IT) infrastructure costs, high availability, flexible storage options and enhanced security, among other benefits. Moreover, a business entity may rely on cloud services for advanced computing solutions, such as high-performance computing, big data analytics and artificial intelligence.

Cloud services may be provided by a wide variety of cloud computing infrastructures. In an example, a business entity may consume cloud services that are provided by a dedicated private cloud computing platform (or “private cloud”) for which the business entity is the sole tenant. The physical resources (e.g., servers, networking devices and storage appliances) of a private cloud computing system may be located in the business entity's on-premise data center or may be located in leased space of a co-location data center. In another example, a business entity may consume cloud services that are provided by a public cloud computing platform (or “public cloud”). A public cloud computing platform is available to members of the general public and is shared by the business entity with other tenants.

A hybrid cloud computing environment (or “hybrid cloud”) combines cloud services that are provided by both private and public cloud computing platforms. A business entity may choose a hybrid cloud computing environment for any of a number of reasons. In an example, a business entity may store its sensitive data on a private cloud computing platform, and one or multiple public cloud computing platforms may host the business entity's application workloads. In another example, in furtherance of a disaster recovery plan, a private cloud computing platform may host a business entity's application workloads and store the business entity's data; and the business entity may rely on a public cloud computing platform-provided disaster recovery service for the application workloads and data. In another example, as part of a development operations (DevOps) pipeline, a business entity may develop and test application workloads using public cloud computing platform-provided cloud services; and the business entity may deploy production application workloads on a private cloud computing platform. In another example, a business entity may use a private cloud computing platform for edge computing, and the business entity may rely on public cloud computing platform-provided cloud services to further process edge-acquired data (e.g., apply multiple machine learning models). In another example, a private cloud computing platform may host application workloads for a business entity, and the business entity may rely on one or multiple public cloud computing platforms for overflow for periods of high application workload demand.

A unified API provides a cloud computing platform agnostic interface for provisioning, deploying and managing cloud resources in a hybrid cloud computing environment. In the context that is used herein, “cloud resources” refer to physical or virtual deliverables that are provided by cloud services. In examples, cloud resources may be virtual machines, bare-metal environments, orchestrated container environments, container orchestration engines, applications, containers, files, storage objects, storage blocks, databases, functions, firewalls, virtual network devices, network load balancers, and so forth.

A business entity may assign labels, referred to as “resource tags” herein, to cloud resources. A resource tag corresponds to metadata that describes an attribute or affiliation of a cloud resource to which the resource tag is assigned. In an example, a resource tag associates a cloud resource with a particular division within a business entity, such as a particular department or group of the business entity. In another example, a resource tag associates a cloud resource with a particular project name used by the business entity. In another example, a resource tag associates a cloud resource with a particular owner of the cloud resource. In another example, a resource tag associates a cloud resource with a particular microservice. In another example, a resource tag associates a cloud resource with a particular business function. In another example, a resource tag associates a cloud resource with a particular application operating environment. In another example, a resource tag associates a cloud resource with a particular group of resources. In another example, a resource tag identifies an expiration time or an expiration date for a cloud resource. A resource tag may associate a cloud resource with a particular purpose. In examples, a resource tag may identify an importance or criticality of a cloud resource, associate a cloud resource with a particular workload demand or indicate that the cloud resource is to be used as overflow during periods of high workload demand.

A resource tag may have any of a number of purposes related to the tracking, usage or status of the cloud resource to which the resource tag is assigned. In an example, a business entity may use resource tags for cost metering purposes to track cloud computing costs and attribute the costs to specific departments, groups or projects of the business entity. In another example, a business entity may use resource tags to facilitate cloud resource searching (e.g., to readily find all cloud resources associated with a particular project). In another example, resource tags may be used for application workload demand-based resource scaling for purposes of identifying cloud resources that are to be used for periods of relatively high application workload demand and/or identifying cloud resources that are not to be used for periods of relatively low application workload demand. In another example, resource tags may be used to identify underutilized or unused cloud resources. In another example, resource tags may be used for access control governance for purposes of regulating access rights to cloud resources. In another example, resource tags, by associating cloud resources with importances or criticalities, may aid security intrusion detection and/or security intrusion remediation.

Regardless of a particular resource tag usage, it may be beneficial to assign the same resource tag to all applicable cloud resources of a hybrid cloud computing environment, regardless of the underlying hosting cloud computing platforms that host these cloud resources. For example, a resource tag that represents Department ABC is assigned to all cloud resources whose costs may be attributed to Department ABC, regardless of the underlying cloud computing platforms. Assigning the same resource tag to resources across all cloud computing platforms of a hybrid cloud computing environment may be challenging, however, as each cloud computing platform may impose a different set of rules (called a “tag validity ruleset” herein) defining a permissible resource tag syntax.

In an example, the resource tag is a key-value pair, and each cloud computing platform specifies a tag validity ruleset setting forth permissible characters for the key, the maximum length of the key, permissible characters for the value and the maximum length of the value. A resource tag that has a syntax that meets the criteria imposed by a particular cloud computing platform's tag validity ruleset is referred to herein as satisfying, or complying, with the ruleset. To the contrary, a resource tag that has a syntax that does not meet the criteria imposed by a tag validity ruleset is referred to herein as not complying with the ruleset.

Assigning non-complying resource tags to cloud resources may have unintended consequences. For example, a cloud computing platform may discard or remove a non-complying resource tag unbeknownst to the business entity relying on the resource tag. Consequentially, the cloud resource to which the non-complying resource tag is assigned may not be tracked or otherwise used as intended.

In accordance with example implementations that are described herein, a hybrid cloud computing environment is associated with a private cloud computing platform and one or multiple public cloud computing platforms. Each cloud computing platform has an associated cloud service owner. Accordingly, the hybrid cloud computing environment is associated with a number of cloud computing platforms and respective associated cloud service owners. Each cloud service owner specifies an associated tag validity ruleset, which defines the permissible syntax for resource tags that are assigned to cloud resources that are hosted by the corresponding cloud computing platform. The hybrid cloud computing environment includes a hybrid cloud manager that provides a unified API for purposes of provisioning, deploying and managing cloud resources in the hybrid cloud computing environment. In accordance with example implementations, the unified API has an associated API call group (called the “centralized tagging service API call group” herein) that corresponds to a centralized resource tagging service.

Before a cloud resource owner uses the unified API to deploy a cloud resource, the cloud resource owner may create one or multiple resource tags and assign the resource tag(s) to the cloud resource. A particular newly-created resource tag may not, however, comply with all of the tag validity rulesets. The centralized tagging service may be queried, by a cloud resource owner, about a resource tag (called a “candidate resource tag” herein) before the associated resource is deployed to the hybrid cloud computing environment for purposes of validating the resource tag. In this context, a “valid” resource tag refers to a resource tag that complies with all of the tag validity rulesets of the hybrid cloud computing environment. If the centralized tagging service responds that the candidate resource tag is valid, then the cloud resource owner is assured that the same resource tag may be assigned to multiple cloud resources within the hybrid cloud computing environment, regardless of the underlying cloud computing platforms that host the cloud resources.

As further described herein, the centralized tagging service also allows cloud service owners to add, modify or replace tag validity rulesets. The centralized tagging service, as further described herein, determines whether a particular modification to a tag validity ruleset or a new tag validity ruleset affects the validity of any resource tags that have already been assigned to deployed cloud resources. More specifically, the centralized tagging service determines if a modification of a tag validity ruleset (e.g., a modification of a tag validity ruleset for an existing cloud service) or the addition of a tag validity ruleset (e.g., a new tag validity ruleset for a cloud service provided by a new cloud service provider) results in a more restrictive resource tag syntax. If so, the centralized tagging service determines whether any of the resource tags assigned to deployed cloud resources no longer comply with the more restrictive resource tag syntax. The centralized tagging service remediates any existing resource tag non-compliance, as further described herein.

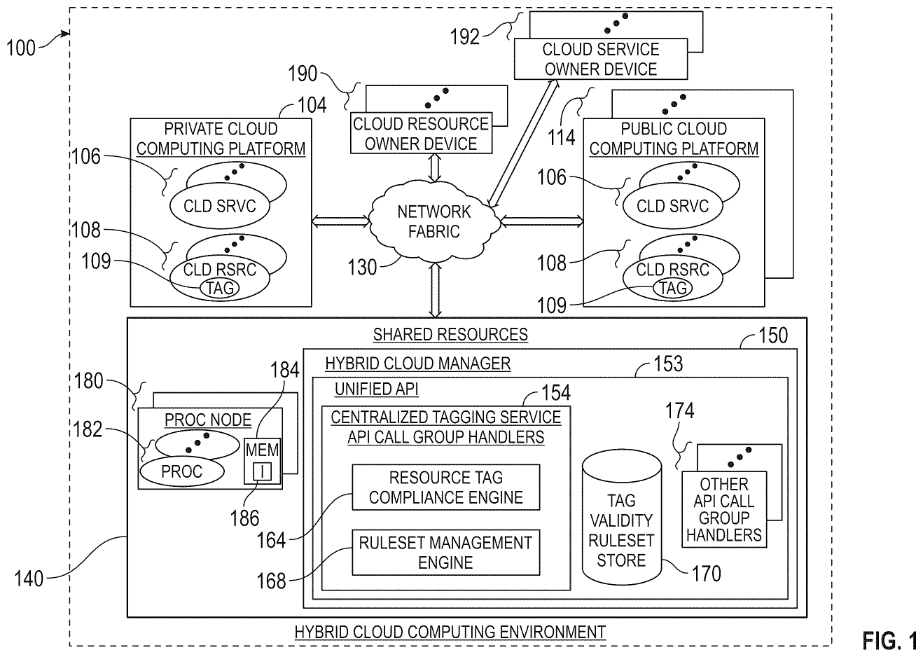

As a more specific example, FIG. 1 depicts a hybrid cloud computing environment 100 in accordance with example implementations. In the context that is used herein a “hybrid cloud computing environment” includes a private cloud computing platform (e.g., a private cloud computing platform 104) and one or multiple public cloud computing platforms (e.g., public cloud computing platforms 114). In the context that is used herein, a “cloud computing platform” (or “cloud”) generally refers to a computer system having resources (e.g., compute resources, storage resources and networking resources) that may be scaled up or down on demand. In the following description, a “cloud computing platform 104,114” refers to either the private cloud computing platform 104 or a public cloud computing platform 114.

The private cloud computing platform 104 and the public cloud computing platforms 114 are connected to network fabric 130. In accordance with example implementations, the network fabric 130 may be associated with one or multiple types of communication networks, such as Compute eXpress Link (CXL) fabric, dedicated management networks, local area networks (LANs), wide area networks (WANs), global networks (e.g., the Internet), wireless networks, or any combination thereof.

A cloud computing platform 104,114 includes actual, or physical, hosting resources. In an example, the physical hosting resources for a cloud computing platform 104,114 include server-provided central processing unit (CPU) cores, graphics processing unit (GPU) cores, physical memories and physical storage devices. In another example, the physical hosting resources include storage appliances. In another example, the physical hosting resources include networking devices, such as top-of-the-rack (ToR) switches, network switches, network routers, network bridges and network gateways. A cloud computing platform 104, 114 provides application operating environments that are supported by the underlying physical hosting resources of the platform 104, 114. A bare-metal environment is an example of an application operating environment. A virtual machine, a container and an orchestrated container cluster are other examples of application operating environments.

A cloud computing platform 104,114 provides one or multiple cloud services 106 (or “cloud service instances 106”). A cloud service 106 provides one or multiple virtual and/or physical deliverables called “cloud resources 108” (or “deployed cloud resources 108”) herein. A particular cloud service 106 adheres, or corresponds, to a particular cloud service model. In an example, a cloud service 106 corresponds to an Infrastructure-as-a-Service (IaaS) model and delivers an IT infrastructure, such as cloud resources 108 that correspond to compute, storage and networking components. In another example, a cloud service 106 corresponds to a Platform-as-a-Service (PaaS) model and delivers cloud resources 108 corresponding to an IT infrastructure as well as delivers cloud resources 108 that facilitate application development and deployment in the cloud, such as middleware, database managers, container orchestration engines, business analytics software, and so forth. In another example, a cloud service 106 corresponds to a Software-as-a-Service (SaaS) model and delivers one or multiple cloud resources 108 in the form of applications. In another example, a given cloud service 106 corresponds to a Storage-as-a-Service (STaaS) model and delivers storage-related cloud resources 108 (e.g., block storage cloud resources 108, file storage cloud resources 108 or object storage cloud resources 108). In another example, a given cloud service 106 corresponds to a Function-as-a-Service (FaaS) model and delivers one or multiple function-related cloud resources 108. In another example, a given cloud service 106 corresponds to a Containers-as-a-Service (CaaS) model and delivers one or multiple container cloud resources 108. In another example, a given cloud service 106 corresponds to a Disaster Recovery-as-a-Service (DRaaS) model and delivers one or multiple disaster recovery virtual machine cloud resources 108.

A cloud resource owner may assign one or multiple labels, referred to as “resource tags 109” (or “cloud resource tags 109”) herein, to a particular cloud resource 108. In accordance with example implementations, a resource tag 109 corresponds to metadata that represents one or multiple strings of characters.

In a more specific example, in accordance with some implementations, a resource tag 109 corresponds to metadata that represents a key-value pair. The key-value pair represents an attribute or affiliation of a cloud resource 108 to which the resource tag 109 is assigned. The key and the value may be respective strings of characters. The “key” of the key-value pair is an identifier that describes a category or characterization of the “value” of the key-value pair. For example, a resource tag 109 includes a key that categorizes the value as being a “Department,” the value of the resource tag 109 specifies “ABC,” and the combination of the key and the value associates the assigned cloud resource 108 with “Department ABC.” In another example, a resource tag 109 includes the key “Department” and a value of “DEF” to associate the assigned cloud resource 108 with “Department DEF.” In another example, a resource tag 109 includes the key “Project” and a value “123” to associate the assigned cloud resource 108 with “Project 123.”

Each cloud computing platform 104, 114 may have a different set of rules (referred to as a “tag validity ruleset” herein) that defines a permissible resource tag syntax for resource tags 109 that are assigned to cloud resources 108 that are hosted on the cloud computing platform 104, 114. In an example, a permissible resource tag syntax corresponds to a set of characters that are allowed for a resource tag 109. In another example, a permissible resource tag syntax corresponds to one or multiple ways in which characters may or may not be arranged in a string of a resource tag 109 (e.g., resource tag syntax prohibits a particular string prefix). In another example, a permissible resource tag syntax corresponds to a maximum allowable character string length for a resource tag 109. In another example, a permissible resource tag syntax corresponds to a minimum allowable character string length for a resource tag 109. Moreover, a permissible resource tag syntax may correspond to different syntax rules for the tag and value of a key-value pair.

In a more specific example, the tag validity ruleset for a particular public cloud computing platform 114, Platform A, specifies that the resource tag key is limited to Unicode characters and cannot have a prefix of “xyz” or “XYZ”. At least part of the tag validity ruleset for the key for Platform A may be concisely represented by a regular expression, or “regex,” of “\hat{ }([\p{L}\p{Z}\p{N}_.:/=+\−@]*)$”. The regex defines a pattern of permissible characters for the key. For this example, the tag validity ruleset for Platform A limits the resource tag key to the set of Unicode letters, digits, white-space and the following characters: “_”, “.”, “/”, “=”, “+”, “−”, “:”, and “@”. The tag validity ruleset for Platform A, for this example, further specifies that the key is limited to a maximum length of 128 characters. The resource tag syntax rules for the Platform A further specify, for the value, a regex of “\hat{ }([\p{L}\p{Z}\p{N}_.: /=+\−@]*)$”. For this example, the tag validity ruleset limits the value to the set of Unicode letters, digits, white-space and the following characters: “_”, “.”, “/”, “=”, “+”, “−”, “:”, and “@”. The tag validity ruleset further specifies, for this example, that the resource tag value is limited to a maximum length of 256 characters.

In another example, the tag validity ruleset for another public cloud computing platform 114, Platform B, specifies that the resource tag key can contain UTF-8 encoded Unicode characters, except for single quotes ('), double quotes (“), back slashes (\), and forward slashes (/). The tag validity ruleset for Platform B may further limit the key length to 256 characters. The tag validity ruleset for Platform B further specifies, for this example, that the resource tag value can contain UTF-8 encoded Unicode characters, except for single quotes ('), double quotes (”), back slashes (\), and forward slashes (/). Moreover, for this example, the tag validity ruleset limits the resource tag value to a length of 256 characters.

As can be appreciated, a resource tag may be constructed that complies with the tag validity ruleset for one cloud computing platform 104,114 but does not comply with the tag validity ruleset for another cloud computing platform 104,114. For example, a resource tag having a key with a forward slash (/) character may comply with the tag validity ruleset for Platform A, but due to the forward slash (/), the resource tag does not comply with the tag validity ruleset for Platform B. In another example, a resource tag having a key of 200 characters may comply with the tag validity ruleset for Platform B, but due to the character length, the resource tag does not comply with the tag validity ruleset for Platform A. Accordingly, neither resource tags in either of the foregoing two examples can be assigned to applicable resources on both Platform A and Platform B due to the syntax rule non-compliances. In the context that is used herein, the resource tags for the foregoing two examples are referred to as being “invalid.”

The hybrid cloud computing environment 100, in accordance with example implementations, is associated with two primary user profiles, or personas: a cloud resource owner persona and a cloud service owner persona. Users having the cloud resource owner persona are affiliated with the owner of the cloud resources 108 and have credentials to provision and deploy the cloud resources 108, including creating and assigning resource tags 109 to cloud resources 108. Users having the cloud resource owner persona may access a server (called a “hybrid cloud manager 150” herein) of the hybrid cloud computing environment 100 using cloud resource owner client devices 190 (e.g., laptop computers, tablet computers, desktop computers, smartphones and so forth) that are connected to the network fabric 130. In an example, the cloud resource owner is a business entity that owns the private cloud computing platform 104, consumes cloud services 106 provided by the private cloud computing platform 104, and subscribes to cloud services 106 that are provided by the public cloud computing platforms 114.

Each public cloud computing platform 114, in accordance with example implementations, is associated with a different cloud service owner persona. Moreover, in accordance with example implementations, the private cloud computing platform 104 is associated with a particular cloud service owner persona. Users affiliated with a cloud service owner persona have credentials to modify, replace or add a tag validity ruleset defining permissible syntax for the corresponding cloud platform 104,114. Users associated with a cloud service owner persona may access the hybrid cloud manager 150 using cloud resource owner client devices 192 (e.g., laptop computers, tablet computers, desktop computers, smartphones and so forth) that are connected to the network fabric 130.

In accordance with example implementations, the hybrid cloud manager 150 provides a unified API 153 for purposes of provisioning, deploying and managing cloud resources 108 of the hybrid cloud computing environment 100. The unified API 153 includes APIs of a centralized tagging service API call group 154. The centralized tagging service API call group 154 corresponds to a centralized resource tagging service. The unified API 153 also serves API calls to other API call groups 174 corresponding to other services (e.g., resource provisioning, deploying and managing services) other than the centralized tagging service.

For the example implementation that is depicted in FIG. 1, the hybrid cloud manager 150 is hosted on shared resources 140 that are affiliated with a public cloud computing platform, such as, in an example, one of the public cloud computing platforms 114. Accordingly, in some implementations, the hybrid cloud manager 150 is affiliated with a public cloud service owner. In another example, the hybrid cloud manager 150 is hosted on the private cloud computing platform 104 and is therefore associated with a private cloud service owner. In another example, the hybrid cloud manager 150 is hosted on private non-cloud resources.

A user affiliated with the cloud resource owner persona may, through interaction with a cloud service owner web portal, query the centralized tagging service about the validity of a candidate resource tag that is intended to be assigned to a cloud resource. This query occurs, in accordance with example implementations, before the cloud resource is deployed. The query is used to validate the candidate resource tag, i.e., learn whether the candidate resource tag complies with the tag validity rulesets of all of the cloud computing platforms 104,114. The resource tag validation assures that the same resource tag 109 may be assigned to cloud resources 108 within the hybrid cloud computing environment 100, regardless of the underlying cloud computing platforms 104,114 that host the cloud resources 108. The centralized tagging service may also be updated by users affiliated with cloud service owner personas with new, updated and/or modified tag validity rulesets.

In a more specific example, a user that is affiliated with the cloud resource owner persona may access a web site, or portal, that is served by the hybrid cloud manager 150 for purposes of provisioning and deploying a cloud resource 108 in the hybrid cloud computing environment 100. In an example, the user may access the web portal through an Internet browser of a cloud resource owner client device 190. In this manner, the user may interact with a graphical user interface (GUI) that is served by the hybrid cloud manager 150 through button selections, text entry, menu selections, and so forth, for purposes of furthering the provisioning and deployment of a cloud resource 108. As part of the preparation for deploying a cloud resource 108 in the hybrid cloud computing environment 100, a user, through interactions with the web portal, may create a candidate resource tag to be assigned to the cloud resource and request validation of the candidate resource tag.

In a more specific example, a user may request validation of a candidate resource tag by selecting (e.g., selecting via a mouse or selecting using another user input device) a graphically displayed Validate button that the web portal specifically associates with validating a candidate resource tag. In another example, a user may request validation of a candidate resource tag by selecting a graphically displayed Validate button that the web portal specifically associates with validating a cloud resource (e.g., validating the candidate resource tag as well as validating other aspects associated with the deployment) before the cloud resource can be deployed. Regardless of how validation of a candidate resource tag is requested or initiated, the cloud resource owner client device 190 (e.g., an Internet browser of the client device 190) submits an API call (referred to as an “API request” herein) to an API of the centralized tagging service API call group 154. The API request corresponds to a query, or inquiry, as to whether or not the candidate resource tag complies with all of the tag validity rulesets that are specified by all of the cloud service owners. This determination of compliance or non-compliance is also referred to herein as determining whether the candidate resource tag is valid (compliant) or non-compliant (invalid).

Responsive to the API request, an API handler (or “API handler engine”), which is referred to as the “resource tag compliance engine 164” herein and associated with the centralized tagging service API call group 154, determines whether the candidate resource tag is valid and provides a corresponding API response. The API response contains information regarding the candidate resource tag's validity as well as possibly includes information related to tag non-compliance remediation, as further described herein. For purposes of determining the validity of the candidate resource tag, the resource tag compliance engine 164 checks the candidate resource tag against tag validity ruleset records that are contained in a tag validity ruleset store 170.

Each tag validity ruleset record, in accordance with example implementations, is associated with a particular cloud service owner (and cloud computing platform) and contains data representing resource tag syntax rules that are specified by the cloud service owner. In accordance with example implementations, a tag validity ruleset record contains data representing a collection of rules representing a permissible resource tag syntax space.

Through the API response, information is sent back to the requesting cloud resource owner client device 190 to indicate, among other possible information, the compliance determination result (e.g., indicates whether the candidate resource tag is valid or invalid). In an example, the API response contains data representing graphical content to be displayed by an Internet browser of the cloud resource owner client device 190 informing the cloud resource owner about the validity or invalidity of candidate resource tag.

In accordance with example implementations, if the candidate resource tag does not comply with all of the tag validity rulesets, the tag compliance engine 164 remediates the non-compliance (referred to as “resource tag remediation” herein). In the context that is used herein, “resource tag remediation” refers to one or multiple actions to cure or at least aid in curing non-compliance of a resource tag with one or multiple tag validity rulesets. In an example, resource tag remediation includes the tag compliance engine 164 identifying, via data contained in the API response, the tag validity ruleset or rulesets to which the candidate resource tag does not comply. For example, the API response includes data representing graphical content to be displayed by the Internet browser of the cloud resource owner client device 190 representing the tag validity ruleset(s) that are not satisfied by the candidate resource tag. In another example, resource tag remediation includes the tag compliance engine 164 providing, via the API response, a reason or reasons for the non-compliance. In another example, resource tag remediation includes the tag compliance engine 164, via the API response, identifying a particular noncomplying character or a particular group of noncomplying characters in the candidate resource tag. In another example, resource tag remediation includes the tag compliance engine 164 providing, via an API response, guidance or a recommendation for an alternative candidate resource tag (or a group of alternative candidate resources) that would comply with all of the tag validity rulesets.

In accordance with example implementations, the centralized tagging service API call group 154 serves non-resource tag validity-related API calls that are initiated by cloud resource owner-affiliated users via interaction with a cloud resource owner web portal. These other API calls may, for example, be used for purposes of managing resource tags 109 that are assigned to deployed cloud resources 108. The unified API 153 has API handlers 174 to handle such API calls and provide the appropriate API responses. In an example, these other API calls may include an API call to search for information about cloud resources 108 based on one or multiple resource tags 109. For example, an API call to search for information about cloud resources 108 may result in an API response that causes the cloud resource owner web portal to display information about cloud resources identified by the search. In another example, the other API calls may include an API call to change or replace a resource tag 109 assigned to a deployed cloud resource 108 or may include an API call to add a resource tag 109 to a deployed cloud resource 108. The changing, replacement or addition of a resource tag 109 may also produce an API call that is handled by the resource tag compliance engine 164 for purposes of querying whether the resource tag 109 is valid. In another example, the other API calls may include an API call to delete a resource tag 109. In another example, the other API calls may include an API call to create a resource tag 109 and apply the resource tag to a particular group of resources 108.

In addition to serving API requests from users affiliated with the cloud resource owner persona, the centralized tagging service also serves API requests by users affiliated with cloud service owner personas. In an example, users affiliated with cloud service owner personas may use the centralized tagging service to add, replace and/or modify tag validity rulesets. Regardless of whether a tag validity ruleset is added, replaced or modified, a record representing a new or modified tag validity ruleset is stored in the tag validity ruleset store 170. In this manner, a cloud service owner may add a tag validity ruleset to the centralized tagging service when the cloud service owner adds a cloud service 106, or a cloud service owner may modify or replace a tag validity ruleset for an existing cloud service 106.

In a more specific example, a user affiliated with the cloud service owner persona may access a cloud service owner web portal associated with the unified API 153 with the appropriate credentials for purposes of adding, replacing or modifying a tag validity ruleset. In an example, the user, through an Internet browser of a cloud service owner client device 192, accesses a web portal that is served by the hybrid cloud manager 150. The user may, through interaction (e.g., button selections, text entry, menu selections and so forth) with the web portal, add, replace or modify a tag validity ruleset. These actions may result in one or multiple API requests being sent to the centralized tagging service API call group 154 of the unified API 153. An API handler (or “API handler engine”), which is referred to as the “ruleset management engine 168” herein, responds to API calls directed to adding, replacing or modifying tag validity rulesets.

The ruleset management engine 168, in addition to making the ruleset addition, replacement or modification, also determines whether the ruleset change affects the validity of any of the resource tags 109 (also called “existing resource tags 109” herein) that are assigned to deployed cloud resources 108. More specifically, the ruleset management engine 168 determines whether a newly added or changed ruleset is more restrictive in any aspect than the existing collection of tag validity rulesets (as represented by the records contained in the tag validity ruleset store 170). Stated differently, the ruleset management engine 168 evaluates the union of the permissible resource tag syntaxes that correspond to all of the tag validity rulesets for purposes of determining whether the addition or change has further restricted the permissible resource tag syntax space. If the new or modified tag validity ruleset further restricts the permissible resource tag syntax space, then the ruleset management engine 168 checks the resource tags 109 assigned to the deployed cloud resources 108 against the more restrictive resource tag syntax criteria. For this purpose, the ruleset management engine 168 checks the resource tags 109 against the modified or added tag validity ruleset. If the ruleset management engine 168 determines, as a result of this check, that a resource tag 109 is no longer valid, then the ruleset management engine 168 performs resource tag remediation.

In an example, resource tag remediation includes the ruleset management engine 168 notifying (e.g., emailing or calling an API served by the cloud resource owner web portal) to notify the cloud resource owner about a non-complying resource tag 109. In another example, resource tag remediation includes the ruleset management engine 168 providing, to the cloud resource owner, a suggested modification to the resource tag 109 to bring the resource tag 109 into compliance. In another example, resource tag remediation includes the ruleset management engine 168 modifying a non-complying resource tag 109 so that the resource tag 109 as modified complies with all of the tag validity rulesets. In another example, resource tag remediation includes the ruleset management engine 168 storing information representing the non-complying resource tags 109 and sending reminders to the cloud resource owner for purposes of prompting the cloud resource owner to correct the non-complying resource tags 109.

In the context that is used herein, an application programming interface, or “API,” refers to a collection of software components that establish a relationship between inputs and outputs. For this purpose, the software components collectively provide one or multiple functions, operations or actions. As described herein, an API request (or “API call”) is an input provided by a requestor and is directed to invoking one or multiple functions, operations or actions of a particular API for purposes of producing one or multiple outputs. In response to a particular API request, an API may provide an output, called an “API response,” which the API sends back to the requestor. In an example, an API request and API response may be communicated using a hypertext transfer protocol secure (HTTPS) connection. In an example, API requests and API responses correspond to the Representational State Transfer, or “REST,” API call model. In another example, API requests and API responses correspond to an API call model other than the REST API call model, such as a remote procedure call (RPC) model or other API call model.

In accordance with example implementations, an API request that is sent to the unified API 153 is a web API call that includes a request Uniform Resource Locator (URL). In an example, the request URL includes an identifier (e.g., a domain name and one or multiple sub-domains) of the cloud service owner associated with the hybrid cloud manager 150. In an example, the request URL includes a geographical service region identifier. In an example, the request URL includes an API call group identifier, which represents a category, or classification, of the underlying API call (e.g., an API call group identifier corresponding to the centralized tagging service API call group 154). In an example, the request URL includes a client identifier that identifies the client (e.g., a cloud resource owner for tag validity inquiries or a cloud service owner for tag validity ruleset updates) that generated the API request. In an example, the client identifier may correspond to an authentication bearer token (ABT). The resource path of the request URL may, in an example, contain content (e.g., a text string or other identifier) that represents one or multiple subcategories of an API call group. In an example, a subcategory of the centralized tagging service API call group 154 includes resource tag validity inquiry-related API calls that are handled by the resource tag compliance engine 164. In another example, a subcategory of the centralized tagging service API call group 154 includes ruleset management-related API calls that are handled by the ruleset management engine 168.

As used herein, an “engine,” such as the resource tag compliance engine 164 or the ruleset management engine 168, can refer to one or more circuits. For example, the circuits may be hardware processing circuits, which can include any or some combination of a CPU, a core of a CPU, a microprocessor, a core of a multi-core microprocessor, a microcontroller, a programmable integrated circuit (e.g., a programmable logic device (PLD), such as a complex PLD, or “CPLD”), a programmable gate array (e.g., field programmable gate array (FPGA)), an application specific integrated circuit (ASIC), or another hardware processing circuit. An “engine” can refer to a combination of one or more hardware processing circuits and machine-readable instructions (software and/or firmware) that are executable on the one or more hardware processing circuits. In other examples, an engine can be formed in whole or in part by a CPLD, a PLD, an ASIC, an FPGA or other hardware.

The shared resources 140 that host the hybrid cloud manager 150 include one or multiple processing nodes 180. Each processing node 180, in accordance with example implementations, includes one or multiple processing cores 182 (e.g., CPU cores) and a memory 184. In general, the memory devices that form the memory 184, as well as other memories and storage media that are described herein, may be formed from non-transitory memory devices, such as semiconductor storage devices, flash memory devices, memristors, phase change memory devices, a combination of one or more of the foregoing storage technologies, and so forth. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

In accordance with example implementations, each processing node 180 includes one or multiple processing cores 182 (e.g., CPU cores). A particular hardware processor may be formed from one or multiple processing cores 182 that are part of one or multiple processing nodes 180. One or multiple hardware processors executing on one or multiple processing nodes 180 may execute hardware processor-readable instructions 186 (e.g., instructions stored in the memory 184) for purposes of providing one or multiple instances of the hybrid cloud manager 150.

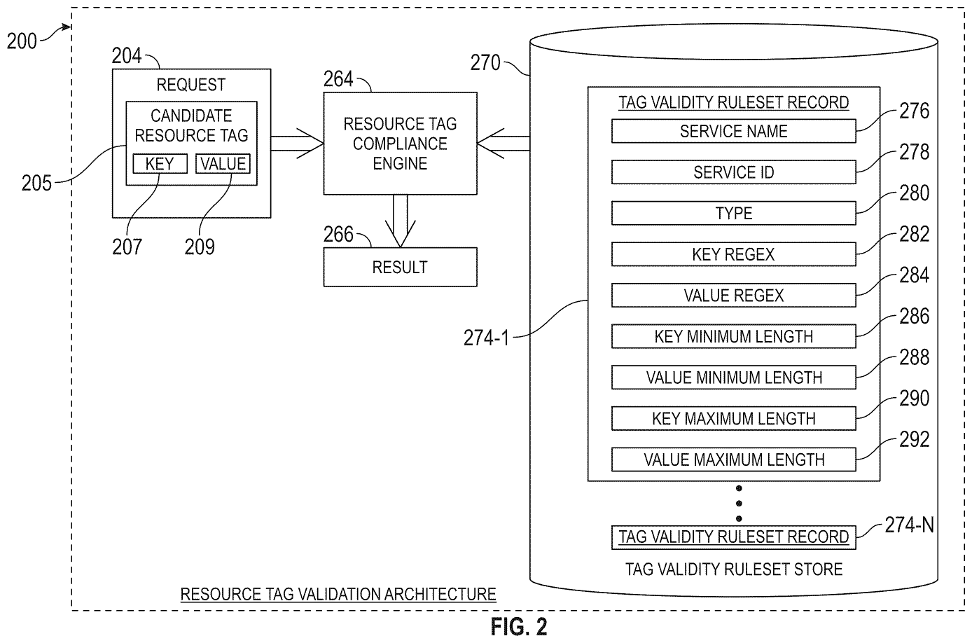

FIG. 2 depicts a resource tag validation architecture 200 in accordance with example implementations. The resource tag validation architecture 200 includes a resource tag compliance engine 264 and a tag validity ruleset store 270. The resource tag compliance engine 164 and the tag validity ruleset store 170 of FIG. 1 are examples of the resource tag compliance engine 264 and the tag validity ruleset store 270, respectively.

Referring to FIG. 2, the resource tag compliance engine 264 may receive a request 204 containing data that represents a candidate resource tag 205. For this example, the candidate resource tag 205 includes metadata that represents a key-value pair. In this manner, the key-value pair includes a key 207 and a corresponding value 209. In an example, the request 204 is an API request that corresponds to a query as to whether the key 207 and the value 209 comply with all tag validity rulesets specified by the cloud service owners of a hybrid cloud computing environment.

The resource tag compliance engine 264, in accordance with example implementations, is an API handler for an API call group of a unified API for the hybrid cloud computing environment. Responsive to the request 204, the resource tag compliance engine 264 checks the key 207 and the value 209 against N tag validity ruleset records 274 (example tag validity ruleset record 274-1 and 274-N being depicted in FIG. 2) for purposes of determining whether the candidate resource tag 205 is valid. In an example, each tag validity ruleset record 274 is associated with a different cloud computing platform (and corresponding cloud service owner) of the hybrid cloud computing environment.

FIG. 2 depicts example content of the tag validity ruleset record 274-1. The other tag validity ruleset records 274 may have similar fields to the fields depicted for the tag validity record 274-1, in accordance with example implementations. In another example, the tag validity ruleset records 274 are associated with corresponding cloud services, and a given cloud computing platform, in accordance with example implementations, is associated with a collection of tag validity ruleset records 274, with each record 274 being associated with a different cloud service provided by the platform.

The tag validity ruleset record 274-1 includes a field 276 containing data representing a cloud service name associated with the record 274-1. The tag validity ruleset record 274-1 further includes a field 278 representing a service identification (ID). In an example, the service ID is a Universally Unique Identifier (UUID) that alternatively may be referred to as a Globally Unique Identifier, or “GUID.” The service ID uniquely identifies the corresponding cloud service. In accordance with example implementations, the UUID is a namespace that is 128 bits long and is described in, “A Universally Unique IDentifier (UUID) URN Namespace,” Request for Comments (RFC) 4122 (July 2015).

In accordance with example implementations, the tag validity ruleset record 274-1 includes a field 280 that contains metadata representing a type of the cloud service. In an example, the type of service corresponds to a particular cloud service model (e.g., an IaaS model, PaaS model, SaaS model, STaaS model, FaaS model, DRaaS model, or other model).

The tag validity ruleset record 274-1 further includes metadata setting forth specific rules that define the permissible syntax for the resource tags that are assigned to resources associated with the cloud service. More specifically, the tag validity ruleset record 274-1 includes a field 282 representing a regex for the key and a field 284 representing a regex for the value. Accordingly, the resource tag compliance engine 264, when evaluating the key 207 and the value 209, tests the key regex specified in the field 282 with the key 207 value and tests the value regex specified in the field 284 with the value 209. In an example, testing the key 207 includes testing a string corresponding to the key 207 with the key regex, and the testing of the string returns either a Boolean FALSE (a match does not occur, and the key 207 is non-compliant) or a Boolean TRUE (a match occurs, and the key 207 is compliant). In a similar manner, testing the value 209 includes testing a string corresponding to the value 209 with the value regex, and the testing of the string returns either a Boolean FALSE (a match does not occur, and the value 209 is non-compliant) or a Boolean TRUE (a match occurs, and the value 209 is compliant).

The tag validity ruleset record 274-1, in accordance with example implementations, further specifies length criteria for the key 207 and the value 209. More specifically, for the example implementation depicted in FIG. 2, the tag validity ruleset record 274-1 includes fields 286 and 288 that set forth minimum respective lengths for the key 207 and the value 209, respectively. Moreover, the tag validity ruleset record 274-1 includes fields 290 and 292 that set forth respective maximum lengths for the key 207 and the value 209.

The resource tag compliance engine 284 provides a result 266 representing the validity evaluation of the candidate resource tag 205. In an example, the result 266 is an API response that contains data representing whether or not the candidate resource tag 205 is valid for use in the hybrid cloud computing environment. In an example, the API response includes data representing graphical content to be displayed on a cloud resource owner web portal indicating whether or not the candidate resource tag 205 is valid. In another example, the result 266 is an API response that includes data representing that the candidate resource tag 205 is invalid and further includes data identifying the non-complying character or characters. In an example, the API response includes data representing graphical content representing the tag invalidity and representing the non-complying character or characters. In another example, the result 266 is an API response that includes data representing that the candidate resource tag 205 is invalid and further includes data representing one or multiple changes to the candidate resource tag 205 to bring the tag 205 into compliance. In an example, the API response incudes data representing graphical content that indicates that the candidate resource tag 205 is invalid and further indicates the one or multiple changes to cure the non-compliance.

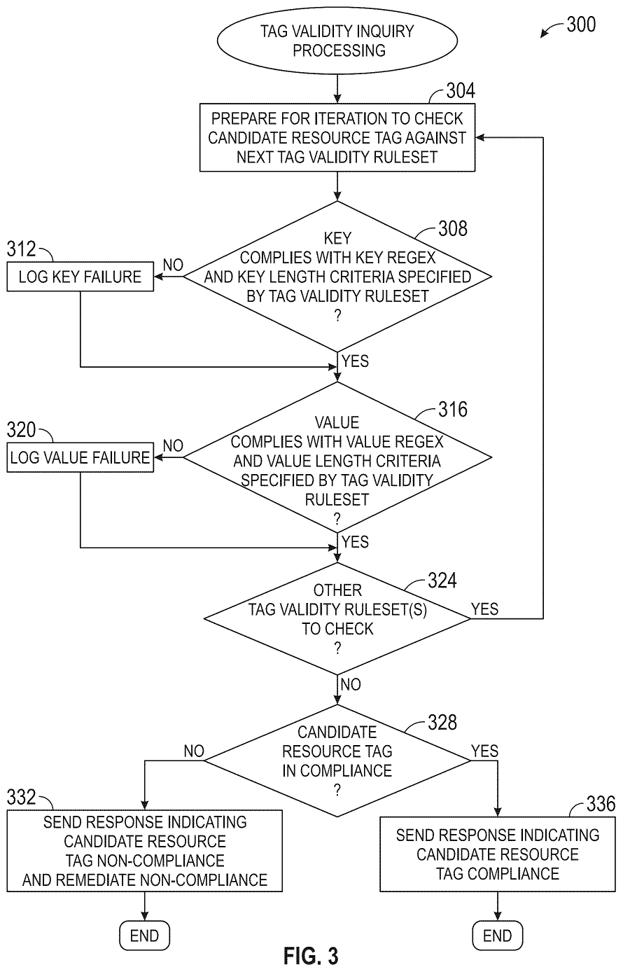

FIG. 3 depicts a technique 300 to validate a candidate resource tag and remediate candidate resource tag non-compliance according to an example implementation. In an example, the technique 300 may be performed by an API handler, such as a resource tag compliance engine (e.g., the resource tag compliance engine 164 of FIG. 1 or the resource tag compliance engine 264 of FIG. 2).

Referring to FIG. 3, the technique 300 includes the resource tag compliance engine performing multiple iterations, with each iteration checking a candidate resource tag against a particular tag validity ruleset. In an example, each iteration includes the resource tag compliance engine checking the candidate resource tag against a particular tag validity ruleset record of a collection of tag validity ruleset records (e.g., the tag validity ruleset records 274 of FIG. 2).

The resource tag compliance engine, pursuant to the technique 300, prepares for an iteration to check a candidate resource tag against the next tag validity ruleset. Each iteration includes checking the candidate resource tag against rules specifying permissible syntaxes for the key and value of the candidate resource tag. More specifically, pursuant to decision block 308, the resource tag compliance engine determines whether the key of the candidate resource tag complies with the key regex and length specified by the tag validity ruleset. In an example, decision block 308 includes determining whether the key of the candidate resource tag has a pattern that complies with the regex and has a length that is under a maximum length specified by the tag validity ruleset. In another example, decision block 308 includes determining whether the key of the candidate resource tag has a pattern that complies with the regex and is longer than a minimum length specified by the tag validity ruleset. In another example, decision block 308 includes determining whether the key has a pattern that complies with the regex and has a length that is within a length range specified by minimum and maximum lengths set forth by the tag validity ruleset. If, pursuant to decision block 308, the key does not comply with the permissible syntax specified by the tag validity ruleset, then, as depicted in block 312, the resource tag compliance engine logs the key failure.

Pursuant to decision block 316, the resource tag compliance engine determines whether the value of the candidate resource tag complies with the value regex and the value length criteria specified by the tag validity ruleset. In an example, decision block 316 includes the tag compliance engine determining whether the value of the candidate resource tag has a pattern represented by the value regex. In another example, decision block 316 includes the resource tag compliance engine determining whether a length of the value of the candidate resource tag satisfies a minimum length specified by the tag validity ruleset. In another example, decision block 316 includes the resource tag compliance engine determining whether the length of the value of the candidate resource tag complies with a maximum length specified by the tag validity ruleset. If, pursuant to decision block 316, the value does not comply with the criteria set forth in the tag validity ruleset, then the resource tag compliance engine logs the value failure, as depicted at 320.

The iteration concludes with, as depicted by decision block 324, the resource tag compliance engine determining whether there are any remaining tag validity rulesets to check. If so, then control returns to block 304 in which the resource tag compliance engine prepares for another iteration to check the candidate resource tag against the next tag validity ruleset.

Otherwise, the evaluation of the candidate resource tag is complete, and the resource tag compliance engine determines (decision block 328) whether the candidate resource tag is valid (or “in compliance”). In an example, decision block 328 includes the resource tag compliance engine determining whether any key failure(s) or value failure(s) have been logged. If the resource tag compliance engine determines that the candidate resource tag is in compliance, then, as depicted in block 336, the resource tag compliance engine sends a response (e.g., an API response) that includes data representing the compliance, or validity, of the candidate resource tag.

As also depicted in FIG. 3, if, pursuant to decision block 328, the resource tag compliance engine determines that the candidate resource tag is not in compliance (or is invalid), then the resource tag compliance engine sends (block 332) a response (e.g., an API response) indicating the non-compliance, or invalidity, of the candidate resource tag. Moreover, as depicted in block 332, in response to a determination (decision block 328) that the candidate resource tag is invalid, the resource tag compliance engine remediates the non-compliance. As described herein, remediating the non-compliance may involve any of a number of actions, such as including data in the API response indicating the reason(s) for non-compliance; including, in the API response, data representing one or multiple suggested changes to the candidate resource tag to bring the tag into compliance, and so forth.

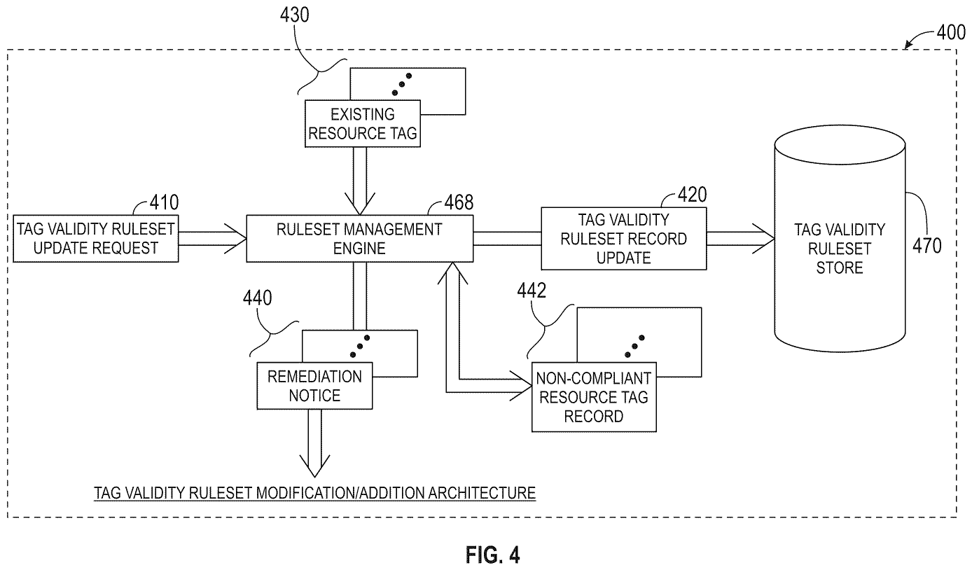

FIG. 4 depicts a tag validity ruleset modification/addition architecture 400 in accordance with example implementations. The architecture 400 includes an API handler, such as a ruleset management engine 468, which serves tag validity ruleset update requests 410 (e.g., API requests) for purposes of updating a tag validity ruleset store 470. In particular, in accordance with example implementations, the ruleset management engine 468 handles API requests from users affiliated with cloud service owner personas for purposes of updating the records of the tag validity ruleset store 470. The ruleset management engine 168 of FIG. 1 is an example of the ruleset management engine 468. The tag validity ruleset store 170 of FIG. 1 and the tag validity ruleset store 270 of FIG. 2 are examples of the tag validity ruleset store 470.

As depicted in FIG. 4, the ruleset management engine 468 may receive a tag validity ruleset update request 410. In an example, the tag validity ruleset update request 410 is an API request associated with a cloud service owner. The tag validity ruleset update request 410 includes data representing a modification, addition or replacement of a tag validity ruleset. Responsive to the tag validity ruleset update request 410, the ruleset management engine 468, as depicted at 420, performs an update of the tag validity ruleset store 470. This update may include, as examples, adding a tag validity ruleset record to the tag validity ruleset store 470, replacing a tag validity ruleset record of the tag validity ruleset store 470, or modifying an existing tag validity ruleset record of the tag validity ruleset store 470. The addition of a tag validity ruleset or the change in an existing tag validity ruleset may further restrict the permissible resource tag syntax space. If the resource syntax space is now more restrictive, then this means that one or multiple existing resource tags 430 (i.e., resource tags 430 assigned to deployed cloud resources) may be invalid. Therefore, in accordance with example implementations, responsive to a tag validity ruleset being added or updated, the ruleset management engine 468 determines whether the new or changed tag validity ruleset imposes a more restrictive resource tag syntax, and if so, the ruleset management engine 468 re-evaluates the existing resource tags 430.

Responsive to the ruleset management engine 468 determining that a particular existing resource tag 430 is invalid, the ruleset management engine 468 then performs one or multiple remediation actions. For example, as depicted in FIG. 4, the ruleset management engine 468 may send out remediation notices 440 for non-complying existing resource tags 430. In an example, a remediation notice 440 may correspond to an API request sent by the ruleset management engine 468 to the corresponding cloud resource owner, notifying the cloud resource owner of the non-complying existing resource tag 430. In an example, the cloud resource owner's website portal may display a notice corresponding to the invalid resource tag 430. In another example, the ruleset management engine 468 may temporarily fix, or cure, the non-compliance by modifying existing resource tag 430 to change the non-complying character(s). In accordance with some implementations, as depicted at 442, the ruleset management engine 468 stores data representing invalid existing resource tags. In this manner, the ruleset management engine 468 may, in response to the failure of the cloud resource owner to correct the non-complying existing resource tag, may resend a particular remediation notice 440, among other possible actions.

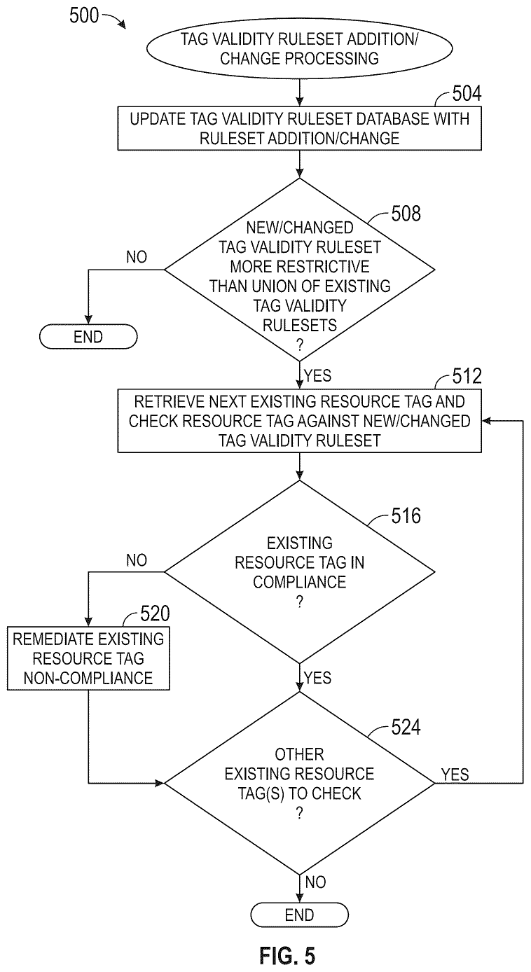

FIG. 5 depicts a technique 500 to process a request to add, modify or replace a resource tag validity ruleset according to example implementations. In an example, the technique 500 may be performed by an API handler (or “API handler engine”) of a unified API, such as a ruleset management engine (e.g., the ruleset management engine 168 of FIG. 1 or the ruleset management engine 468 of FIG. 4).

Referring to FIG. 5, the technique 500 includes, pursuant to block 504, the ruleset management engine first updating a tag validity ruleset database with a ruleset addition or change. The ruleset management engine determines (decision block 508), whether the new or changed tag validity ruleset is more restrictive than a union of existing tag validity rulesets. If not, then the technique 500 terminates.

If, pursuant to decision block 508, the ruleset management engine determines that the new or changed tag validity ruleset is more respective, then the ruleset management engine checks the existing resource tags assigned to deployed cloud resources for purposes of determining whether these resource tags comply with the more restrictive resource tag syntax criteria. For the example implementation that is depicted in FIG. 5, this determination involves the ruleset management engine performing a sequence of iterations in which the ruleset management engine evaluates an existing resource tag in each iteration for purposes of determining whether the resource tag is still valid, or in compliance. More specifically, as depicted in FIG. 5, the ruleset management engine determines (decision block 516) whether the existing resource tag is in compliance. For this purpose, the ruleset management engine, in accordance with example implementations, determines whether the existing resource tag complies with the new or changed tag validity ruleset. If not, then, as depicted in block 520, the ruleset management engine remediates the existing resource tag's non-compliance.

In an example, the remediation includes the ruleset management engine sending a notice to the corresponding cloud service owner. In another example, the remediation includes the ruleset management engine changing the non-complying character or characters to bring the existing resource tag into compliance, and the ruleset management engine further sends a notice to the cloud resource owner. As depicted in decision block 524, the ruleset management engine determines whether there are other existing resource tags to check, and if so, control returns to block 512 to perform another iteration for purposes of checking the compliance of another existing resource tag.

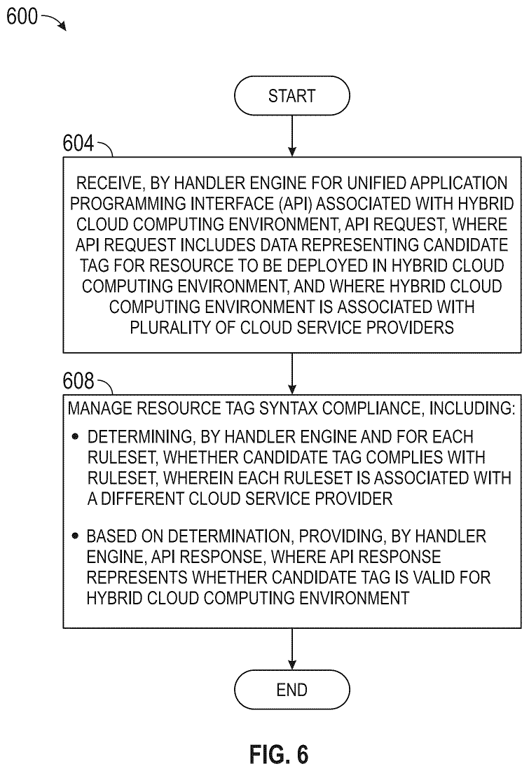

Referring to FIG. 6, in accordance with example implementations, a technique includes receiving (block 604), by a handler engine for a unified application programming interface (API) associated with a hybrid cloud computing environment, an API request. In an example, the hybrid cloud computing environment includes a private cloud computing platform and multiple public cloud computing platforms. In an example, the unified API is hosted on the private cloud computing platform. In another example, the unified API is hosted on a public cloud computing platform. In an example, the unified API provides a cloud computing platform agnostic interface for provisioning, deploying and managing cloud resources in the hybrid cloud computing environment.

The API request includes data representing a candidate tag for a resource to be deployed in the hybrid cloud computing environment. In an example, the candidate tag is a candidate label for a cloud resource to which the tag is to be assigned. In an example, the API request corresponds to an inquiry as to a validity of the candidate tag.

In an example, the candidate tag corresponds to a key-value pair. In an example, the candidate tag contains metadata that describes an attribute or affiliation of the cloud resource. In an example, the candidate tag associates the cloud resource with a particular division within a business entity, such as a particular department or group of the business entity. In another example, the candidate tag associates the cloud resource with a particular project name. In another example, the candidate tag associates the cloud resource with a particular owner of the cloud resource. In another example, the candidate tag associates the resource with a particular microservice. In another example, a candidate tag associates the cloud resource with a particular owner. In another example, the candidate tag associates the cloud resource with a particular application operating environment. In another example, the candidate tag associates the cloud resource with a particular group of resources. In another example, the candidate tag identifies an expiration time or expiration date for the cloud resource. In another example, the candidate tag associates the cloud resource with a particular purpose. In other examples, the candidate tag identifies an importance or criticality of the cloud resource, associate the cloud resource with a particular workload demand or indicates that the cloud resource is to be used as overflow during periods of high workload demand.

In an example, a cloud resource is an infrastructure component that is provided by a cloud service. In an example, a cloud resource is a virtual machine. In another example, a cloud resource is a bare-metal environment. In another example, a cloud resource is an orchestrated container environment. In another example, a cloud resource is a container orchestration engine. In another example, a cloud resource is an application. In another example, a cloud resource is a container. In another example, a cloud resource is a file. In another example, a cloud resource is a storage object. In another example, a cloud resource is a storage block. In another example, a cloud resource is a database. In another example, a cloud resource is a function. In another example, a cloud resource is a firewall. In another example, a cloud resource is a virtual network device. In another example, a cloud resource is a network load balancer. A cloud service may adhere to any of a number of cloud service models. IaaS, PaaS, SaaS, STaaS, FaaS, CaaS and DRaaS are examples of cloud service models.

Pursuant to block 608, the technique 600 includes managing a resource tag syntax compliance. Managing the resource tag compliance includes determining, by the handler engine, and for each ruleset of a plurality of rulesets, whether the candidate tag complies with the ruleset. Each ruleset is associated with a different cloud service provider. In an example, a ruleset specifies permissible characters that may be used for resource tags assigned to resources associated with cloud services provided by the cloud service provider. In another example, a ruleset specifies permissible characters that may not be used for resource tags assigned to resources provided by the cloud service provider. In another example, a ruleset specifies a prohibited prefix for resource tag keys assigned to resources provided by the cloud service provider. In another example, a ruleset specifies a length criteria for a permissible length for resource tag values assigned to resources provided by the cloud service provider. In another example, a ruleset specifies a regex for permissible resource tag keys. In another example, a ruleset specifies a regex for permissible resource tag values.

As also depicted in block 608, managing resource tag syntax compliance further includes, based on the determination, providing, by the handler engine, an API response. The API response represents whether the candidate tag is valid for the hybrid cloud computing environment. In an example, the API response includes data to cause a cloud resource owner web portal to indicate that the candidate tag is valid. In another example, the API response includes data to cause a cloud resource owner web portal to indicate that the candidate tag is invalid. In another example, the API response includes data to remediate non-compliance of the candidate tag with the plurality of rulesets. In an example, the remediation includes data to cause a cloud resource owner web portal to indicate a reason why the candidate tag is invalid. In an example, the remediation includes data to cause a cloud resource owner web portal to indicate a guidance to bring the candidate tag into compliance.

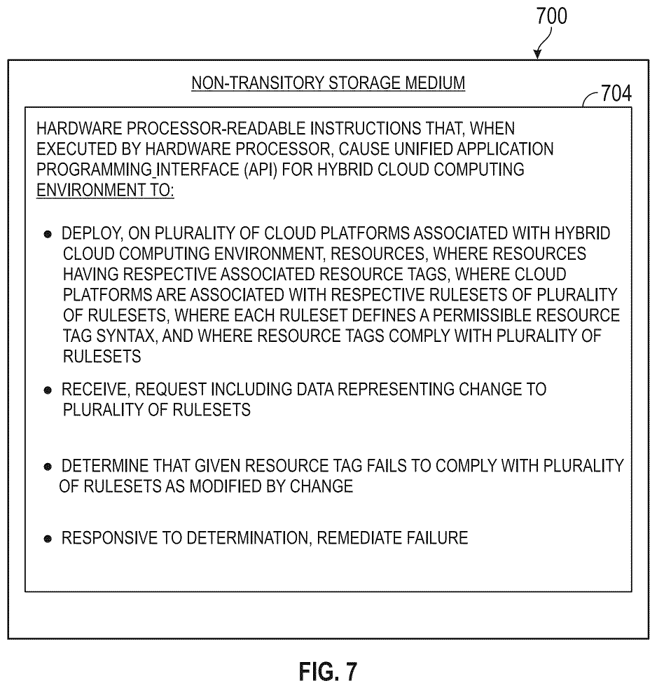

Referring to FIG. 7, in accordance with example implementations, a non-transitory storage medium 700 stores hardware processor-readable instructions 704. The instructions 704, when executed by a hardware processor, cause a unified application programming interface (API) for a hybrid cloud computing environment to deploy, on a plurality of cloud computing platforms associated with the hybrid cloud computing environment, resources. In an example, the hardware processor may include one or multiple processing cores. In an example, the hybrid cloud computing environment includes a private cloud computing platform and multiple public cloud computing platforms.

In an example, the resources are infrastructure components that are provided by cloud services. A virtual machine is an example of a resource. A bare-metal environment is another example of a resource. An orchestrated container environment is another example of a resource. A container orchestration engine is another example of a resource. An application is another example of a resource. A container is another example of a resource. A file is another example of a resource. A storage object is another example of a resource. A storage block is another example of a resource. A database is another example of a resource. A function is another example of a resource. A firewall is another example of a resource. A virtual network device is another example of a resource. A network load balancer is another example of a resource. A cloud service may adhere to any of a number of cloud service models. IaaS, PaaS, SaaS, STaaS, FaaS, CaaS and DRaaS are examples of cloud service models

The resources have respective associated resource tags. In an example, a resource tag corresponds to a key-value pair. In an example, a resource tag contains metadata that describes an attribute or affiliation of the resource. In an example, a resource tag associates a resource with a particular division within a business entity, such as a particular department or group of the business entity. In another example, a resource tag associates a resource with a particular project name. In another example, a resource tag associates a resource with a particular owner of the resource. In another example, a resource tag associates a resource with a particular microservice. In another example, a resource tag associates a resource with a particular owner. In another example, a resource tag associates a resource with a particular application operating environment. In another example, a resource tag associates a resource with a particular group of resources. In another example, a resource tag identifies an expiration time or expiration date for a resource. In another example, a resource tag associates a resource with a particular purpose. In other examples, a resource tag identifies an importance or criticality of a resource, associates a resource with a particular workload demand or indicates that a resource is to be used as overflow during periods of high workload demand.

The cloud computing platforms are associated with respective rulesets of a plurality of rulesets. Each ruleset defines a permissible resource tag syntax. The resource tags comply with the plurality of rulesets. In an example, a ruleset specifies permissible characters that may be used for resource tags assigned to resources associated with cloud services provided by a cloud service provider. In another example, a ruleset specifies permissible characters that may not be used for resource tags assigned to resources provided by a cloud service provider. In another example, a ruleset specifies a prohibited prefix for resource tag keys assigned to resources provided by a cloud service provider. In another example, a ruleset specifies a length criteria for a permissible length for resource tag values assigned to resources provided by a cloud service provider. In another example, a ruleset specifies a regex for permissible resource tag keys. In another example, a ruleset specifies a regex for permissible resource tag values.

The instructions 704, when executed by the hardware processor, further cause the unified API to receive a request including data representing a change to the plurality of rulesets. In an example, the change corresponds to a new ruleset being added to the plurality of rulesets. In another example, the change corresponds to an existing ruleset of the plurality of rulesets being modified. In another example, the change corresponds to an existing ruleset of the plurality of rulesets being replaced. In an example, the request is associated with a cloud service owner. In an example, the request is associated with a cloud computing platform of the plurality of cloud computing platforms. In an example, the request is made via a cloud service owner web portal.

The instructions 704, when executed by the hardware processor, further cause the unified API to determine whether a given resource tag fails to comply with the plurality of rulesets as modified by the change. In an example, the instructions 704, when executed by the hardware processor, further cause the hardware processor to further determine whether the rulesets, as changed, are more restrictive than the plurality of rulesets before the change. In an example, the instructions 704, when executed by the hardware processor, further cause the hardware processor to determine whether the given resource tag fails to comply with the rulesets as modified by the change responsive to determining that the rulesets, as changed, are more restrictive than the rulesets before the change.

In an example, determining whether the given resource tag fails to comply includes determining whether the given resource tag complies with each ruleset of the plurality of rulesets. In an example, the given resource tag includes a key-value pair, and determining whether the given resource tag complies with a particular ruleset includes testing a string corresponding to the key with a regex specified by the ruleset. In an example, the given resource tag includes a key-value pair, and determining whether the given resource tag complies with a particular ruleset includes testing a string corresponding to the value with a regex specified by the ruleset. In an example, determining whether the given resource tag complies with a particular ruleset includes determining whether the resource tag complies with a length criterion specified by the ruleset.

The instructions 704, when executed by the hardware processor, further cause the unified API to, responsive to the determination, remediate the failure. In an example, remediating the failure includes notifying a cloud resource owner associated with the given resource tag about the failure. In another example, remediating the failure includes providing an API response. In another example, remediating the failure includes providing an API response to cause a cloud resource owner web portal to graphically indicate non-compliance of the given resource tag. In another example, remediating the failure includes providing an API response to cause a cloud resource owner web portal to graphically indicate a reason that the given resource tag is invalid. In another example, remediating the failure includes providing an API response to cause a cloud resource owner web portal to graphically indicate a suggested correction for the given resource tag to cure the non-compliance of the given resource tag.

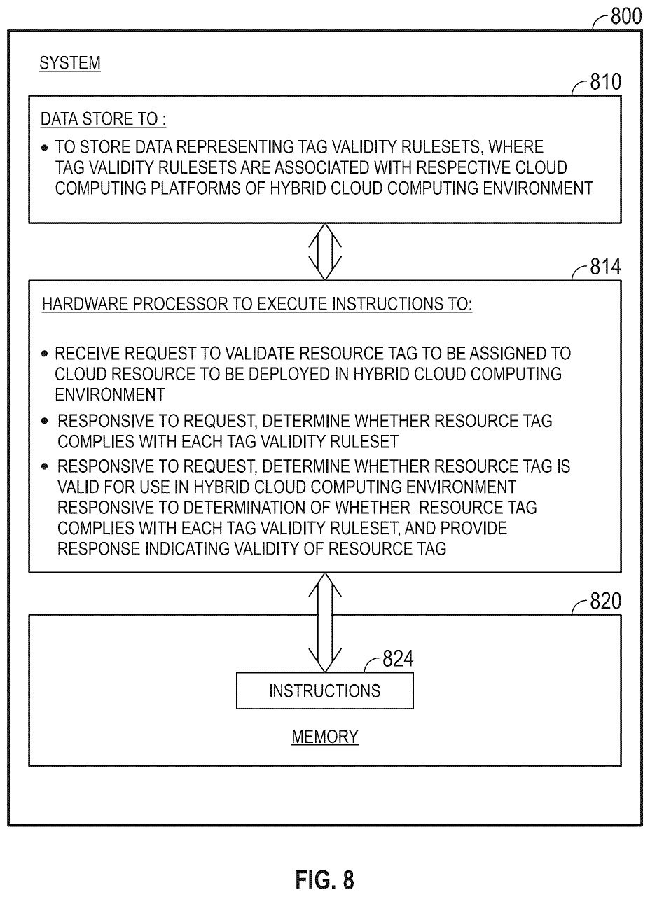

Referring to FIG. 8, in accordance with example implementations, a system 800 includes a data store 810, a memory 820 and a hardware processor 814. In an example, the memory 820 is a collection of semiconductor storage devices. In an example, the hardware processor 814 may include one or multiple CPU cores. In an example, the system 800 corresponds to a hybrid cloud manager. In an example, the system 800 provides a unified API that provides a centralized tagging service. In an example, the system 800 corresponds to a public cloud computing platform. In another example, the system 800 corresponds to a private cloud computing platform. In another example, the system 800 corresponds to a non-cloud computing system.

The data store 810 stores data representing tag validity rulesets. In an example, the data store 810 is organized in records, where each record corresponds to a particular tag validity ruleset. The tag validity rulesets are associated with respective cloud computing platforms of a hybrid cloud computing environment. In an example, the hybrid cloud computing environment includes a private cloud computing platform and multiple public cloud computing platforms. Each tag validity ruleset defines a permissible resource tag syntax. In an example, a tag validity ruleset specifies permissible characters that may be used for resource tags assigned to resources associated with cloud services provided by the cloud service provider. In another example, a tag validity ruleset specifies permissible characters that may not be used for resource tags assigned to resources provided by the cloud service provider. In another example, a tag validity ruleset specifies a prohibited prefix for resource tag keys assigned to resources provided by the cloud service provider. In another example, a tag validity ruleset specifies a length criteria for a permissible length for resource tag values assigned to resources provided by the cloud service provider. In another example, a tag validity ruleset specifies a regex for permissible resource tag keys. In another example, a tag validity ruleset specifies a regex for permissible resource tag values.

The memory 820 stores instructions 824. The hardware processor 814 executes the instructions 824 to validate a resource tag to be assigned to a cloud resource to be deployed to a given cloud computing platform of the cloud computing platforms. The hardware processor 814 to execute the instructions 824 to determine whether the resource tag complies with each tag validity ruleset. In another example, the resource tag includes a key-value pair, and determining whether the resource tag complies with a particular tag validity ruleset includes testing a string corresponding to the key with a regex specified by the tag validity ruleset. In another example, the given resource tag includes a key-value pair, and determining whether the resource tag complies with a particular tag validity ruleset includes testing a string corresponding to the value with a regex specified by the tag validity ruleset. In another example, determining whether the resource tag complies with a particular tag validity ruleset includes determining whether the resource tag complies with a length criterion specified by the ruleset.

In an example, the resource tag includes a key-value pair, and determining whether the resource tag complies with a particular tag validity ruleset includes determining whether the key satisfies a minimum length criterion specified by the tag validity ruleset. In another example, determining whether the resource tag complies with a particular tag validity ruleset includes determining whether the key satisfies a maximum length criterion specified by the tag validity ruleset. In another example, determining whether the resource tag complies with a particular tag validity ruleset includes determining whether the value satisfies a minimum length criterion specified by the tag validity ruleset. In another example, determining whether the resource tag complies with a particular tag validity ruleset includes determining whether the value satisfies a maximum length criterion specified by the tag validity ruleset. In another example, determining whether the resource tag complies with a particular tag validity ruleset includes determining whether the key has a prohibited prefix.

The hardware processor 814 to execute the instructions 824 to determine whether the resource tag is valid for use in the hybrid cloud computing environment responsive to the determination of whether the resource tag complies with each tag validity ruleset, and provide a response indicating the validity of the resource tag. In an example, the request is an API request, and the response is an API response.

In accordance with example implementations, the API request is received responsive to an input provided via a web portal. Providing the API response causes the web portal to display whether the candidate tag is valid. Among the potential benefits, the unified API confirms resource tag validity to assure that a valid resource tag can be assigned to cloud resources across multiple cloud computing platforms that have different associated resource tag syntax rules.

In accordance with example implementations, determining whether the candidate tag complies with a given ruleset includes determining whether a syntax of the candidate tag complies with syntax rules of the given ruleset. Among the potential benefits, the unified API confirms resource tag validity to assure that a valid resource tag can be assigned to cloud resources across multiple cloud computing platforms that have different associated resource tag syntax rules.

In accordance with example implementations, determining whether the candidate tag complies with a given ruleset includes determining whether the candidate tag satisfies a regex expression. Among the potential benefits, the unified API confirms resource tag validity to assure that a valid resource tag can be assigned to cloud resources across multiple cloud computing platforms that have different associated resource tag syntax rules.

In accordance with example implementations, the candidate tag includes a key and a value. Determining whether the candidate tag complies with a given ruleset of the plurality of rulesets comprises determining whether a syntax of the key complies with the given ruleset and determining whether a syntax of the value complies with the value. Among the potential benefits, the unified API confirms resource tag validity to assure that a valid resource tag can be assigned to cloud resources across multiple cloud computing platforms that have different associated resource tag syntax rules.

In accordance with example implementations, the candidate tag includes a string of characters. A given ruleset indicates a set of valid characters. Determining whether the candidate tag complies with the given ruleset includes determining whether all of the characters of the string of characters is contained in the set of valid character. Among the potential benefits, the unified API confirms resource tag validity to assure that a valid resource tag can be assigned to cloud resources across multiple cloud computing platforms that have different associated resource tag syntax rules.

In accordance with example implementations, the candidate tag includes a string of characters, and a given ruleset indicates a valid range of string lengths. Determining whether the candidate tag complies with the given ruleset includes determining whether the length of the string is in the valid range of string lengths. Among the potential benefits, the unified API confirms resource tag validity to assure that a valid resource tag can be assigned to cloud resources across multiple cloud computing platforms that have different associated resource tag syntax rules.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, and the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
receiving, by a handler engine for a unified application programming interface (API) associated with a hybrid cloud computing environment, an API request, wherein the API request includes data representing a candidate tag for a resource to be deployed in the hybrid cloud computing environment, and wherein the hybrid cloud computing environment is associated with a plurality of cloud service providers; and
managing a resource tag syntax compliance, comprising:
determining, by the handler engine and for each ruleset of a plurality of rulesets, whether the candidate tag complies with the ruleset, wherein each ruleset of the plurality of rulesets is associated with a different cloud service provider of the plurality of cloud service providers; and
based on the determination, providing, by the handler engine, an API response, wherein the API response represents whether the candidate tag is valid for the hybrid cloud computing environment.

2. The method of claim 1, further comprising providing a web portal, wherein:
receiving the API request comprises receiving the API request responsive to input provided via the web portal; and
providing the API response causes the web portal to display whether the candidate tag is valid.

3. The method of claim 1, wherein determining whether the candidate tag complies with a given ruleset of the plurality of rulesets comprises determining whether a syntax of the candidate tag complies with syntax rules of the given ruleset.

4. The method of claim 1, wherein determining whether the candidate tag complies with a given ruleset of the plurality of rulesets comprises determining whether the candidate tag satisfies a regex expression.

5. The method of claim 1, wherein:
the candidate tag comprises a key and a value; and
determining whether the candidate tag complies with a given ruleset of the plurality of rulesets comprises determining whether a syntax of the key complies with the given ruleset and determining whether a syntax of the value complies with the value.

6. The method of claim 1, wherein:
the candidate tag comprises a string of characters;
a given ruleset of the plurality of rulesets indicate a set of valid characters; and
determining whether the candidate tag complies with the given ruleset comprises determining whether all of the characters of the string of characters is contained in the set of valid characters.

7. The method of claim 1, wherein:
the candidate tag comprises a string of characters;
a given ruleset of the plurality of rulesets indicates a valid range of string lengths; and
determining whether the candidate tag complies with the given ruleset comprises determining whether the length of the string is in the valid range of string lengths.

8. A non-transitory storage medium that stores hardware processor-readable instructions that, when executed by a hardware processor, cause a unified application programming interface (API) for a hybrid cloud computing environment to:
deploy, on a plurality of cloud computing platforms associated with the hybrid cloud computing environment, resources, wherein the resources having respective associated resource tags, wherein the cloud computing platforms of the plurality of cloud computing platforms are associated with respective rulesets of a plurality of rulesets, wherein each ruleset defines a permissible resource tag syntax, and wherein the resource tags comply with the plurality of rulesets;
receive, a request, wherein the request includes data representing a change to the plurality of rulesets;
determine that a given resource tag of the plurality of resource tags fails to comply with the plurality of rulesets as modified by the change; and
responsive to the determination, remediate the failure.

9. The storage medium of claim 8, wherein the instructions, when executed by the hardware processor, further cause the unified interface to:
modify the plurality of rulesets based on the change.

10. The storage medium of claim 9, wherein the instructions, when executed by the hardware processor, further cause the unified interface to:
determine whether a collective resource tag syntax defined by the plurality of rulesets after the modification of the plurality of rulesets is more restrictive than a collective resource tag syntax defined by the plurality of rulesets prior to the modification of the plurality of rulesets; and
responsive to determining that the collective resource tag syntax defined by the plurality of rulesets after the modification is more restrictive, evaluate compliance of the given resource tag with the plurality of rulesets.

11. The storage medium of claim 8, wherein the instructions, when executed by the hardware processor, further cause the unified interface to:
responsive to determining that the given resource tag fails to comply with the plurality of rulesets, provide, to a resource owner associated with the given resource tag, data representing a notification of the failure.

12. The storage medium of claim 8, wherein the instructions, when executed by the hardware processor, further cause the unified interface to:
responsive to determining that the given resource tag fails to comply with the plurality of rulesets, provide, to a resource owner associated with the given resource tag, data representing a reason for the failure.

13. The storage medium of claim 8, wherein the instructions, when executed by the hardware processor, further cause the unified interface to:
responsive to determining that the given resource tag fails to comply with the plurality of rulesets, provide, to a resource owner associated with the given resource tag, data representing a recommendation to cure the failure.

14. The storage medium of claim 8, wherein:
the request comprises an application programming interface (API) request; and
the instructions, when executed by the hardware processor, further cause the unified interface to provide an API response comprising data to remediate the failure.

15. A system comprising:
a data store to store data representing tag validity rulesets, wherein the tag validity rulesets are associated with respective cloud computing platforms of a hybrid cloud computing environment;
a memory to store instructions; and
a hardware processor to execute the instructions to:
receive a first request to validate a resource tag to be assigned to a cloud resource to be deployed in the hybrid cloud computing environment;
responsive to the first request, determine whether the resource tag complies with each tag validity ruleset of the tag validity rulesets; and
responsive to the first request, determine whether the resource tag is valid for use in the hybrid cloud computing environment responsive to the determination of whether the resource tag complies with each tag validity ruleset of the tag validity rulesets, and provide a response indicating a validity of the resource tag.

16. The system of claim 15, wherein the hardware processor to further execute the instructions to:
receive, a second request to change to a given tag validity ruleset of the plurality of tag validity rulesets;
change the given tag validity ruleset responsive to the second request; and
determine whether existing resource tags deployed on the cloud computing platforms comply with the plurality of tag validity rulesets after the change.

17. The system of claim 15, wherein the hardware processor to further execute the instructions to provide a unified application programming interface (API) for the hybrid cloud computing environment.

18. The system of claim 15, further comprising a cloud computing platform to host the memory and the hardware processor.

19. The system of claim 15, wherein:
the candidate tag comprises a key and a value; and
the hardware processor to further execute the instructions to determine, for each tag validity ruleset of the plurality of tag validity rulesets, whether a syntax of the key complies with tag validity ruleset and determining whether a syntax of the value complies with the tag validity ruleset.

20. The system of claim 15, wherein:
the candidate tag comprises a key and a value; and
the hardware processor to further execute the instructions to determine, for each tag validity ruleset of the plurality of tag validity rulesets, whether a length of the key complies with a length criterion specified by the tag validity ruleset and determining whether a length of the value complies with a length criterion specified by the tag validity ruleset.
